(19) United States
(12) Patent Application Publication
(10) Pub. No.: US 2011/0288951 A1
(43) Pub. Date: Nov. 24, 2011

(54) SYSTEM AND METHOD FOR BUYING AND SELLING GOODS AND SERVICES VIA AN ONLINE MARKETPLACE

(76) Inventor: Mark McKenzie, Reno, NV (US)

(21) Appl. No.: 13/112,891

(22) Filed: May 20, 2011

Related U.S. Application Data
(60) Provisional application No. 61/346,772, filed on May 20, 2010.

(51) Int. Cl. G06Q 30/00

(52) U.S. Cl. 705/26.2

(57) ABSTRACT

A buying and selling process for selling and buying products and services allows buyers to post their desire-to-buy (DTB) to sellers. The sellers can respond to the DTBs by making desire-to-sell (DTS) Offers which match the DTB criteria that includes the specified product, price and DTB timing. Buyers either chose to accept or reject the offer. After a sufficient number of buyers have accepted the DTS Offer above the minimum volume of buyers for activation, the seller activates the purchase of the product or service. The buyers receive a right-to-buy (RTB) notice from the seller specifying the deal fulfillment process, including confirmation of the right-to-buy price (RTBP).

### CROSS REFERENCE TO RELATED APPLICATIONS

This patent application claims priority to U.S. Provisional Patent Application No. 61/346,772, “Method And Apparatus For Buying And Selling Consumer Durable Goods Via An Online Marketplace” filed 20 May 2010, which is incorporated herein by reference.

### FIELD OF THE INVENTION

The present invention is in the field of marketing, advertising, selling and buying goods and services. More particularly, the present invention is in the field of promoting, selling and buying goods and services via an online marketplace or venue.

### BACKGROUND

Conventional marketing, advertising, selling and buying of physical goods and service products involves sellers and buyers. The buying and selling process can involve sellers, manufacturers, distributors, retailers, and service providers. The seller can initially market and advertise a good or service at a fixed “List Price” which can be a Manufacturer's Suggested Retail Price (MSRP) for consumer goods and then typically offering promotions at some discounted “Sale” price below the List Price. In addition, sometimes sellers will offer additional incentives to attract buyers, or apply consumer segmentation techniques to upgrade or downgrade the features of a particular good or service in order to affect the appearance of flexible pricing. Regardless of the techniques used by sellers, the traditional selling process requires a broadcast of offers from the sellers to potential buyers through various promotional channels. Because the offers for the product may only be directed towards the general population, these offers rarely find an interested buyer and even more rarely will the buyer who receives the advertisement buy the advertised goods or service.

There are multiple breakdowns with traditional selling processes. For example, buyers are overwhelmed with unwanted, irrelevant promotions that have no connection with their actual desire-to-buy. Some sellers continuously advertise everything as always being on “Sale”, making it difficult for the buyer to understand what price point represents a truly good deal. Consumer incentive programs, such as customer loyalty programs and consumer financial incentives, often fail to deliver on their promise or have these program costs factored into the price ultimately paid by the buyers. Another problem is that buyers can freely give away their desire-to-buy, which is the value associated with the cost spent by sellers to find a buyer. This variable cost component is factored into the price of the goods or service, but adds little economic value to the buyers.

Promotion accuracy is also a formidable challenge for sellers, and the techniques for pricing deals and estimating the variable cost to spend on marketing and advertising mostly amount to guesswork. Consumer segmentation involves making choices regarding which variables to use to differentiate consumers of a given goods or service category, and there are many factors out of the seller's control which can reduce the effectiveness of any particular segmentation chosen. For example, consumer behavior can change dramatically with changing economic conditions, unexpected weather conditions, or the emergence of new trends and/or technologies. Different buyer segments attribute different economic value to a goods or service, but it remains extremely difficult for sellers to adopt an accurate pricing model to target specific buyer segments with the right price point at the right time because there is no venue where buyers can signal their demand (i.e. the price they are willing to pay for the goods or service and the date by which they want it). What is needed is an improved system and method for buying and selling goods and service products.

### SUMMARY OF THE INVENTION

The present invention is a system and method for buying and selling products including goods and services wherein buyers can signal their desire to buy goods and services in an online venue which then allows sellers to express their desire to sell to those buyers by making offers which match the buying criteria. The buying and selling process invention solves many of the problems currently associated with selling goods and services by providing an online venue for buyers to indicate what they want, when they want it, and at the price they are willing to pay. Sellers are then able to make offers at varying price points to different segments of buyers aggregated into segments with matching goods or services criteria, facilitating a highly targeted promotion and volume selling process.

The system and method for buying and selling provides an online venue for purchasing goods and services. Sellers can optimize the pricing of individual goods and services to multiple segments of the buying community at varying right-to-buy price points. Buyers can use the system to watch, wish and/or want goods and services by specifying what they want, when they want it and at the price they are willing to pay. The system and method can facilitate highly targeted marketing and advertising promotions, because the venue knows exactly what the buyers' want, when they want it, and the price they are willing to pay. In an embodiment, the valuing, trading and matching of a buyer's desire-to-buy and/or a seller's desire-to-sell is similar to the trading of stock options and stocks.

### BRIEF DESCRIPTION OF THE DRAWINGS

FIG. 1 is a diagrammatic representation of an advertising effects model;

FIG. 2 is an extended and enhanced diagrammatic representation of an advertising effects model;

FIG. 3 is a simplified purchasing flow chart;

FIG. 4 is a demand curve applied to a MSRP sales process;

FIG. 5 is a flow chart of the buyer and seller interactions with the Online Venue;

FIG. 6 is a demand curve applied to a Online Venue sales process; and

FIGS. 7-11 are block diagrams illustrating the distribution of goods, services and information from the Manufacturer or Service Provider to the Consumer.

### DETAILED DESCRIPTION

In order to improve the way that products (goods and services) are purchased, the effectiveness of the advertising should be analyzed. An article by Robert J. Lavidge and Gary A. Steiner in the Journal of Marketing called “A Model for Predictive Measurements of Advertising Effectiveness” was an introduction to the Advertising Hierarchy of Effects Model. This Model describes the seven steps or states through which marketing and advertising promotions must move people to get them from being unaware of a goods/service's existence to the purchase of that goods/service. This model for marketing communications used hierarchy of effects but included persuasion as an important factor in the model.

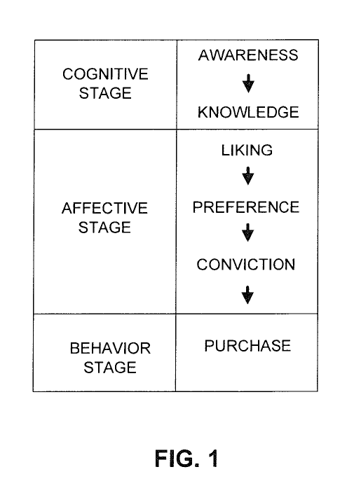

The Model is illustrated in FIG. 1. According to the Lavidge and Steiner Model, a customer who is totally unaware of the product goes through the following six steps before making a purchase: 1) Awareness: The customer becomes aware of the existence of the product. 2) Knowledge: The customer comes to know about the features and uses of the product. 3) Liking: The customer develops a favorable attitude towards the product. 4) Preference: Here, the customer develops preference for the said brand over other competitive products or substitutes. 5) Conviction: This step involves a desire to buy the product. The customer is convinced of a good purchase. 6) Purchase: The customer makes the actual purchase. These six steps can also be grouped into different stages. The Awareness and Knowledge steps are in the Cognitive stage. The Liking, Preference and Conviction steps are in the Affective stage and the Purchase step is in the Behavior stage.

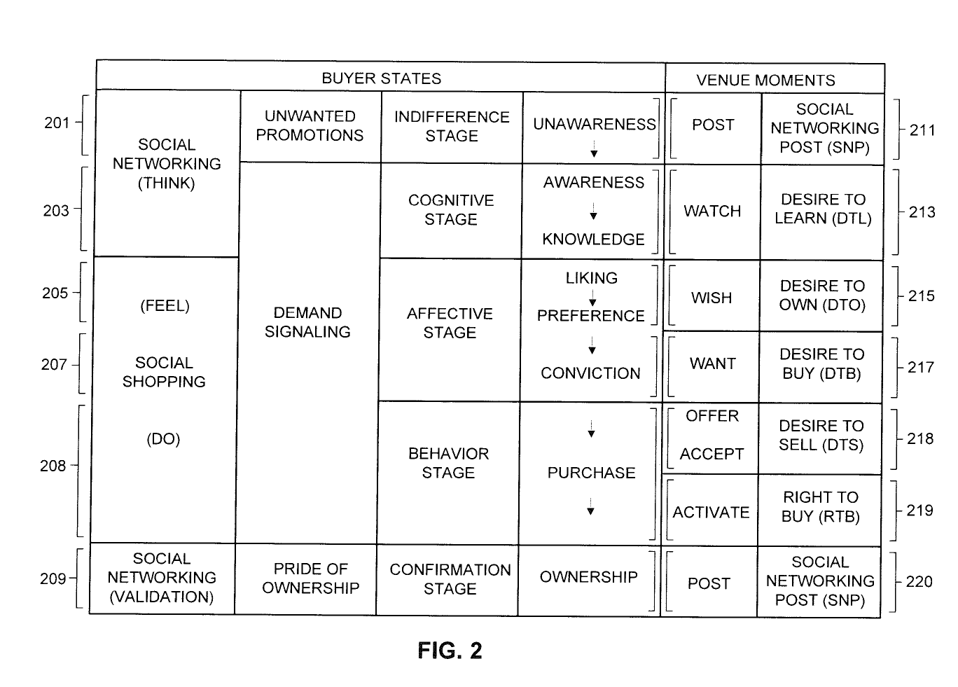

The Lavidge and Steiner Model provided a foundational structure in the formation of the buyer and seller moments which make up the inventive online venue buying and selling system and method. With reference to FIG. 2, the Extended Model further describes the states of an Online Consumer before, during and after the seven steps in the Lavidge and Steiner Model. These additional states are particularly relevant because the Lavidge and Steiner Model predates the Internet and online based consumer purchasing. The Extended Model also describes buyer interactions with social networks, social shopping and demand signaling which are not part of the Lavidge and Steiner Model.

With reference to FIG. 2, The Extended Model shows a sequence of buyer states and venue moments with the top representing the beginning and the bottom representing the end of the purchasing experience. A consumer can be initially unaware of the existence of a goods or service product, and as such that person at best is indifferent to advertising and promotions concerning the goods or service, and at worst feels harassed by unwanted promotions. Because the buyer is not paying attention to the unwanted promotions, the buyer can be in an indifferent stage and have an unawareness of the goods or service 201. The consumer may participate in social networking forums related to the goods or service and could possibly view social network posts (SNP) about the item 211.

The consumer then becomes aware of the product goods or services, and may enter the Cognitive stage related to that goods or service. The consumer starts to watch the goods or service in order to gain knowledge because they have a desire to learn (DTL) about the goods or service, and likely will participate in social networking forums related to the item because they are thinking about it. The consumer has begun to signal their demand for the goods or service. The buyer may consciously think about the goods or services in a Cognitive stage that includes awareness and the knowledge of the goods or services 203. The consumer can be actively watching for information related to the goods or service and may have a desire to learn more 213.

When the consumer's thoughts concerning a goods or service transform into an emotional attachment to that item, the consumer enters the Affective stage wherein they begin to like the goods or service and eventually develop a preference for that goods or service over other possibilities 205. At this stage, the consumer has a desire to own (DTO) the goods or acquire service. The consumers may wish to buy it for themselves, or have a friend or family member buy it for them. The consumer's feelings regarding the goods or service can drive them to signal a DTO the item or service within a social shopping context 215.

While still in the Affective stage, the consumer's feelings regarding the goods or service may turn into action, and these consumers can form a conviction that they want to buy the goods or service 207. This conviction can drive the consumer to signal their desire to buy (DTB) the item in a clear manner within a social shopping context 217. In an embodiment, the system can allow consumers to post a DTB that specifies what goods or service they want, a DTB timing (i.e. the time period within which their desire to buy the goods or service is valid, for example, Day Only, This Week, This Month, Good Until Cancelled, etc.), and the price they are willing to pay for the goods or service.

In response to the DTB posting, the consumer can be open to receiving offers concerning the specified goods or service, which in a social shopping context are expressed as a desire to sell (DTS) on the part of sellers 218. In an embodiment, the DTS offer can occur when the seller indicates the required selling criteria to the buyer which can include: 1) The goods or service that is being offered, 2) The Offer price for the goods or service, 3) The DTS timing i.e. the time period during which the product must be purchased, 4) The minimum volume of buyers required to Accept the offer for deal to Activate. The minimum volume can range from 1 to an unlimited volume, 5) The maximum quantity of the product available for purchase at the specified price. The maximum quantity can also range from 1 to an unlimited volume.

The consumer is now in the Behavior stage, wherein they will review and either accept or reject offers 208. The Accept moment 208 can be when the buyer accepts the seller's offer which can occur in different ways. In one example, the Accept Moment includes the buyer expressing the desire-to-buy during the Want moment, and then receiving at least one offer which matches the buying criteria, and the buyer is willing to Accept at least one offer. In another example, the buyer seeing an existing offer from a seller at the online venue which matches the buyer's buying criteria, and the buyer accepts that existing offer.

When the seller's conditions for activating their offer have been reached, each consumer who has accepted the offer will receive a right to buy the item 219 and may then go on to purchase that item from the seller 208. The Activation moment 219 can be the last step of the purchasing process. The seller has previously made an offer, and the online venue system can monitor the seller's conditions for purchasing the goods or services. For example, in an embodiment, the system may monitor the number of buyers accepting the offer. When the minimum volume of buyers required by the seller to accept the offer has been reached, the seller or system can activate the offer. At the activation moment 219 the system gives all buyers who have previously accepted the offer a right-to-buy (RTB) the product. The RTB can contain: instructions on how to buy the product from the seller and the parameters matching the buying and selling criteria under which the purchase transaction will take place such as the product, the RTB price, the purchase timeframe. Once the final conditions have been met, the seller or system can implement the activate moment 219 and the system can enable the buyer(s) to purchase the goods or services from the seller.

In an embodiment, the final stage of the Extended Model is the Confirmation stage. The consumer enters the Confirmation stage when they own the goods or have experienced the service. The consumer is now looking for validation that the purchase they made was wise and has delivered the economic value they expected relative to the price they paid to build and/or reinforce their pride of ownership in the goods or perception of the quality of service 209. At this stage, the consumer may post information related to their experience with the purchase of the goods or service on social networking forums 220.

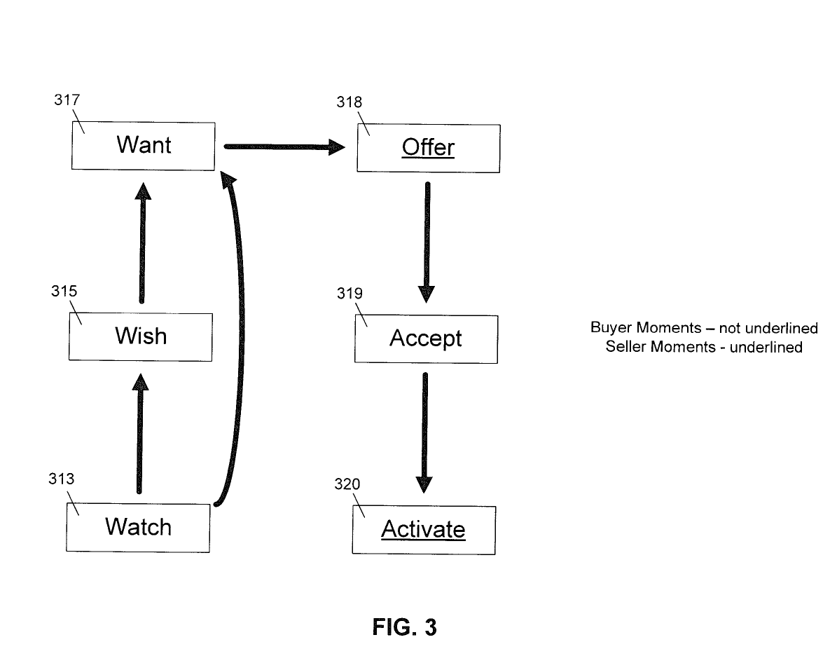

In FIG. 3, the Venue Moments include buyer moments and seller moments as well as fundamental objects in the system. The buyer moments are actions taken by the buyer and the seller moments are actions taken by the seller. The buyer moments and seller moments and corresponding fundamental objects are listed below in Table 1.

TABLE 1

| BUYER | SELLER | |
|---|---|---|
| MOMENT | MOMENT | FUNDAMENTAL OBJECTS |
| POST | | SOCIAL NETWORK POST (SNP) |
| WATCH | | DESIRE TO LEARN (DTL) |
| WISH | | DESIRE TO OWN (DTO) |
| WANT | | DESIRE TO BUY (DTB) |
| | OFFER | DESIRE TO SELL (DTS) |
| ACCEPT | | DESIRE TO SELL (DTS) |
| | ACTIVATE | RIGHT TO BUY (RTB) |
| POST | | SOCIAL NETWORK POST (SNP) |

With reference to FIG. 3, in an embodiment, the basic Venue moments of the Extended Model are illustrated in a simplified flow chart which includes various buyer moments and seller moments. The buyer moments include: Watch 313, Wish 315, Want 317, Accept 319 and the seller moments include: Offer 318 and Activate 320. The buyer can enter the buying process at any of the four buyer moments and the seller can enter the buying process at the Offer 318 moment. For example, a purchase can start with a buyer watching 313 a goods or service. The buyer can then begin to wish 315 he or she had the goods or service. The buyer's desire can then proceed to wanting 317 the goods or service and posting a DTB. Once the buyer wants the goods or service, he or she may seek an offer or the seller may present an offer 318 for the goods or service by posting a DTS. The buyer may then decide to accept or decline the offer. For the purchase to be made, the buyer must accept 319 the offer. If the offer is accepted, the seller or system can activate 320 the purchase by providing a right to buy (RTB) the goods or services in exchange for the offer price. In some embodiments, the watch 313 and wish 315 buyer moments can be optional and are not necessary for completion of a purchase.

With reference to FIG. 3, the purchase process can take various routes through the Venue moment flow chart. For example, the buyer can enter the buying process from the Watch moment 101 and then proceed to the Wish moment 315 or start at the Wish moment 315 and then go to the Want moment 317 or start at the Want moment 317. In other examples, the buyer may progress from the Watch moment 313 directly to the Want moment 317 skipping the Wish moment 315. From the Want moment 317, the buyer may decide to accept an existing Offer 318 from a seller, at which point the buying and selling process would enter the Accept moment 318. Once the seller's offer conditions are completed, the purchase can proceed to the Activation moment 320. The Activation moment 320 completes the purchase transaction for the goods or services.

An important concept of the inventive buying and selling system and method, is that a value can be placed on the desire to buy or sell a goods or service in a similar fashion to the way that stock options are valued in the financial market. Traditionally the entire value in a purchase is associated with the actual transaction when money changes hands and goods or services are received. However, this conventional notion of shopping ignores the value associated with desire to buy and sell prior to the actual purchase. Furthermore, we can equate the value of desire to buy to the fixed plus variable costs spent trying to find a buyer for a particular goods or service, and the value of desire to sell can be equated to the contribution margin anticipated by the seller at various price points.

For example, a desire to buy (or DTB) can now be associated with a “Call Option,” and a desire to sell (or DTS) can be associated with a “Put Option.” We could calculate the values of a DTB or a DTS using a derivative of the Black Scholes equation used in pricing stock options, by using variables such as the underlying value of the goods or service, the date by which the consumer or seller must buy or sell the item or service, the availability of the item or service, seasonal buying patterns and other factors. For example, even the weather can be a variable.

In an Online Venue following the inventive buying and selling process, the value of a DTB or DTS can be used to justify the fees associated with brokering the purchasing of goods or services at desired prices. The Online Venue could engage in arbitrage in a similar fashion to the Bid-Ask spread used in the stock option market, by taking the difference between the desire to buy price and the desire to sell price for a particular goods or service. Eventually, it would also be possible for the Online Venue to become a marketplace for trading DTBs and DTSs just like the stock option market trades Calls and Puts.

Another feature of the Online Venue is that a buyer can indicate the price they are willing to pay for a goods or service. The sellers can then use this information to fluctuate prices of goods or services up and/or down a demand curve to optimize revenues. The Online Venue model has the significant advantage over a more traditional fixed or List Price/MSRP pricing models, because this system allows the seller to capture more revenue and contribution margin by allowing flexible pricing for a particular goods or service. Different price points are required to capture different segments of buyers who attribute varying economic value or utility to the goods or service. Provided each price point at which the goods/service is sold is above the fixed plus variable costs for that item, the buyer segment can be captured with positive contribution margin.

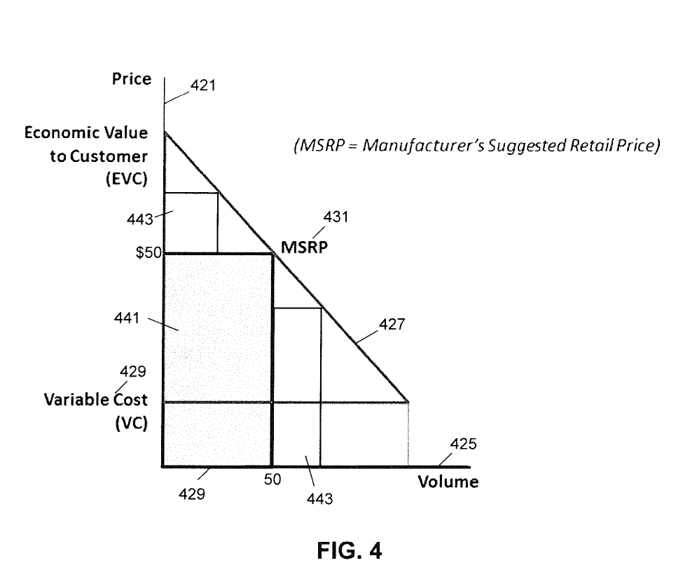

With reference to FIG. 4, a demand curve graph is illustrated having the price as the vertical axis 421 and volume as the horizontal axis 425. In this example, the demand or Economic Value to Customer (EVC) curve 427 shows that the goods have a very high EVC to a small volume of customers, and that the volume of customers increases as the EVC decreases. The Variable Cost (VC) 433 can include the fixed and variable costs attributed to manufacturing costs, service costs, marketing and advertising. The traditional MSRP or List Price model is fundamentally flawed, because it assumes that all customers attribute the same economic value or utility to a particular goods or service. A customer will never pay more than their EVC for a particular product. Thus, only the shaded portion 429 of the entire volume of customers will purchase these goods at the MSRP 431. In this traditional MSRP model, when sellers are unable to move inventory at the fixed price point the sellers can be forced to broadcast discount promotions to every potential buyer regardless of the buyer's current criteria for buying. This model is therefore also making the predominant (and incorrect) assumption that the only thing which matters to the buyers is price.

There are many factors which influence a buyer's decision to buy a particular goods or service. These factors do include price, but they also include timing, demographic variables, geographic variables, psychographic variables and behavioral variables. Together we consider these factors to be the benefits sought, or the economic value to the consumer segment (EVC) at any particular point in time. Sellers attempt to address varying EVC through techniques such as consumer segmentation, by upgrading or downgrading features of a goods or service, or offering more or less Incentives, to affect the appearance of flexible pricing. However, consumer segmentation involves making difficult choices regarding which variables to use to differentiate consumers of a given goods or service category, and there are many factors out of the seller's control which can reduce the effectiveness of any particular segmentation chosen. For example, consumer behavior can change dramatically with changing economic conditions, unexpected weather conditions, or the emergence of new trends and/or technology. Essentially the traditional pricing model only allows the capture of a single segment of buyers at any point in time, limiting the contribution margin captured by the seller to the revenue associated with that segment.

In an embodiment, a yield management system can be used to improve the revenues and contribution margin generated from the sales of goods or services. Yield management can involve strategic control of inventory to sell goods or services to the right customer at the right time for the right price. This process can result in price discrimination, where a firm charges customers consuming otherwise identical goods or services different prices. The yield management can require detailed forecasting and mathematical optimization of marginal revenue opportunities which arise from segmentation of consumers' willingness to pay. For example, with reference to FIG. 4, if the market for a particular good follows the simple straight line Price/Demand relationship, a single fixed price of $50 there is enough demand to sell 50 units of inventory. This results in $2,500 in revenues 441. However the same Price/Demand relationship yields significantly more money if consumers are presented with multiple prices represented by boxes 443.

The segmentation approach can rely upon adequate separation of offers between consumers so that all buyers do not buy at the lowest price offered. In an embodiment, time of purchase can be used to create this segmentation. For example, with a cleaning service around a holiday, later booking customers can pay the higher fees. In contrast, many trend setting goods can use time of purchase by discounting later in the selling season once the item is readily available. The yield management decision-making process inherently has variable yields from segments that are competing for the same inventory. In capacity-constrained goods, the seller may reject lower revenue generating customers in the hopes that the inventory can be sold in a higher valued segment.

A problem with yield management is that the time vs. price process is not exact and is based upon projections of demand rather than any real time measurable demand for consumer durable goods and services. In order to improve upon the yield management, consumers need an effective way to signal the price they are willing to pay and their DTB timing for a particular goods or service, and sellers need an effective way to fluctuate pricing to address varying EVCs. An online social shopping and networking venue can achieve both of these requirements. Through the online system, buyers can signal their desire to buy at different price points and DTB timings, and provide an effective venue for sellers to target segments of buyers with varying EVCs up and down the demand curve.

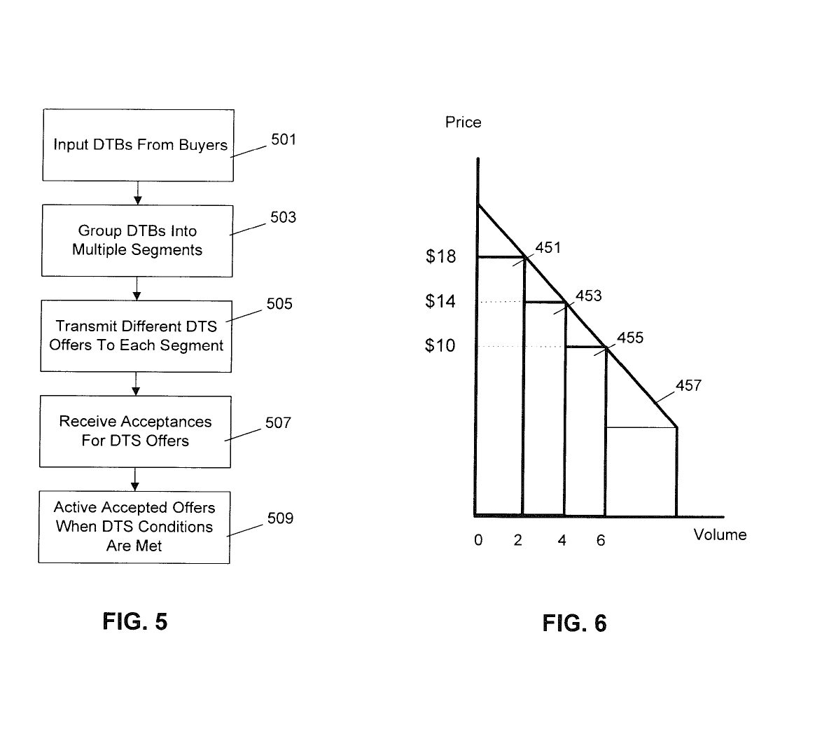

In an embodiment, an internet based Online Venue system can provide a website for selling goods and/or services that is run by one or more computer servers. The website can allow buyers to post their desire to buys (DTBs) and sellers to make offers or DTS in response to the DTBs. The website can also allow sellers to post offers and buyers to accept these offers. With reference to FIG. 5, a flow chart illustrating a purchasing process is illustrated. The buyers can log onto the website and input their DTBs 501 through a user interface. Or buyers can input their DTBs whilst shopping or social networking on other websites by selecting a DTB button previously embedded in the Web Browser's toolbar at the request of the buyer. Or buyers can input their DTBs whilst shopping in a traditional store by using their mobile device with a mobile application of the Online Venue system, which may include a barcode scanning feature. As discussed, the DTBs can include a description of the goods or services, a maximum price the buyer is willing to pay and the DTB timing during which their DTB is valid. The DTBs are posted by the server to both the corresponding buyer and potential sellers to the goods or services.

The sellers can review the DTBs and make offers for the specified goods or services individually or in segments of multiple DTBs. The seller may also request an analysis for revenue optimization from the server. In an embodiment, the server can group the DTBs into multiple segments after a predetermined number of DTBs for a specific good or service are received. The groupings into two or more segments can be based upon various DTB factors. For example, the server can group the DTBs into multiple different segments based upon the maximum prices that the buyers are willing to pay, and the DTB timings during which the DTBs are valid (i.e., Day Only, This Week, This Month, Good Untill Cancelled, etc.) 503. In some cases, the system may place the DTBs in as few as two separate segments or as many as one segment for each DTB. If the maximum purchase prices for an item are: $10, $12, $14, $16, $18 and $20 and the server has been instructed to divide into three segments, it can have a first segment ($18 and $20), a second segment ($14 and $16), and a third segment ($10 and $12). The seller(s) can then transmit offers to the buyers based upon the lower “maximum purchase price” for each of the segments 505.

The buyers will then receive the DTSs and they can respond by either accepting the DTS offer 507 or rejecting the DTS. The seller may have conditions that must be met before the accepted offers can be activated. For example, in some cases, a minimum number of offers must be accepted at the offer price before the sales can be completed. Another possible condition is the delivery date for the goods or services. A seller may not be able to sell large quantities of goods or services that are in short supply immediately, but may be able to complete these sales after a period of time. If time is a condition, the seller may wait until the specified time has elapsed. Once all of the DTS conditions are met, the seller can activate the accepted offers 509. In some cases the maximum price in the DTBs may be below a minimum purchase price which can be set by the seller. These buyers may not be placed in any segment and the seller may not make a DTS to these buyers.

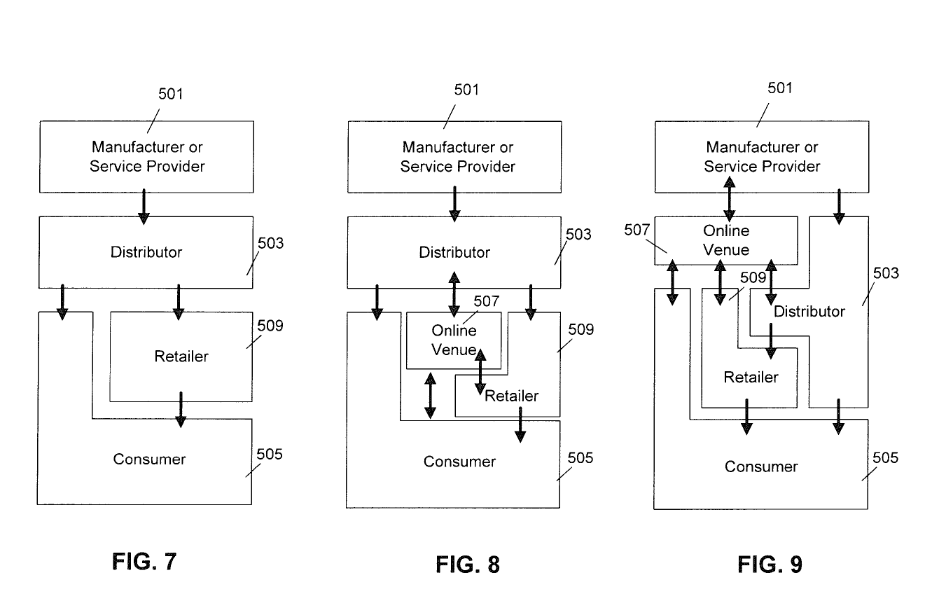

With reference to FIG. 6, the first segment 451, the second segment 453 and the third segment 455 are illustrated under the demand curve 457. If all of the buyers accept the three different DTS offers, the total revenue from the sales will be: 2×$18+2×$14+2×$10=$84. In contrast, if the product was simply offered at $14, the total revenue would only be 4×$14=$56. Thus, there can be a significant improvement in sales and profits by using the described system and method.

In an embodiment, the DTSs can be transmitted to all segments simultaneously. However, it may be preferable to transmit the DTSs to the buyers sequentially. For example, the seller can transmit a first DTS through the server to the first segment with a first offer price of $18. The system can then wait for the first segment to accept the offer. If all of the buyers in the first segment accept the DTS offer, the system can transmit a second DTS with a second offer price of $14 to the second segment. However, if the first DTS was rejected by some of the first segment buyers, the system can transmit the second DTS to both the second segment and the first segment buyers who rejected the first DTS. The server can than transmit the third DTS with a third offer price of $10 to the third segment and any first or second segment buyers who did not purchase at the first or second DTS.

In an embodiment, a main source of revenue for the Online Venue is “Buyer Commit Fees.” This fee can be charged to the buyer when an accepted offer is activated and the buyer receives a right-to-buy (RTB). A considerable benefit of the buyer commit fee in addition to the revenue for the Online Venue, is the psychological commitment on the part of the buyer to follow-through with the purchase after having been charged the commit fee. In an embodiment, the fee is set at a percentage of the transaction price. For example, the fee can be 5% of a transaction right to buy price (RTBP) and can be charged to buyer when the accepted offer is activated by the seller. If the RTBP is $300, a 5% fee is $15 which is charged to each buyer when minimum number of buyers required to activate the deal is reached.

It is also possible for the Online Venue to obtain revenues from other potential sources including: sales of research and social networking areas of site through: advertising revenue, click-through commerce, seller and/or buyer service/membership fee, etc. It may also generate revenue through more sophisticated transaction fee models such as arbitrage price differences between the Desire-to-Buy Price (DTBP) and Desire-to-Sell Price (DTSP) which are similar to Bid-Ask Spread. These fee calculations can be based on a version of Black Scholes equation which can include parameters such as: Purchase Timing, Product Maturity Curve, Product Availability, EVC, etc. In yet another embodiment, it may be possible to trade on the value of Desire-to-Buy and Desire-to-Sell the goods and services.

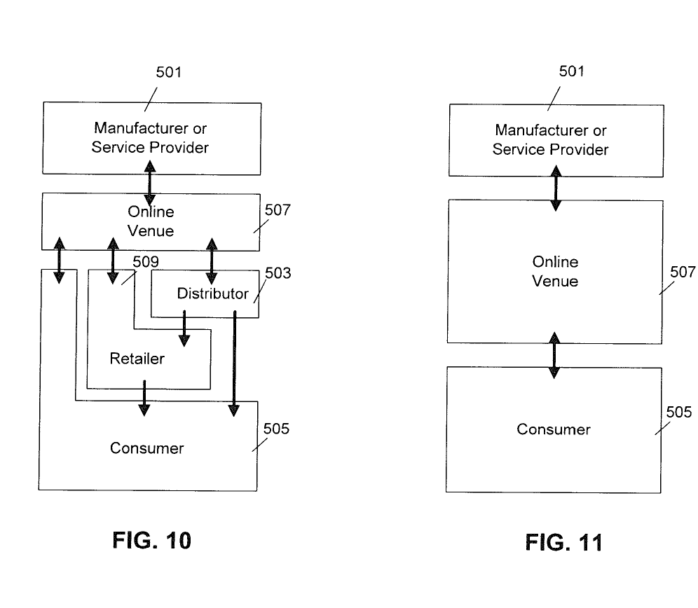

FIGS. 7-11 illustrate how different channels of distribution of goods, services and information from the goods or service provider 501 to the consumer 505 may evolve over time from alternative channel for distributors 503 to ultimately becoming the platform through which manufacturers and service providers 501 route all of their supply chain purchases. With reference to FIG. 7, a current distribution path is illustrated. The goods or services can be transmitted from the manufacturer or service provider 501 to the distributor 503 and then to from the distributor 503 to either the consumer 505 directly or to the retailer 509 and then to the consumer 505. With reference to FIG. 8, the Online Venue 507 is introduced, and as such the distribution of goods, services and purchasing information can be altered. Goods or services from the distributors 503 can be offered through the Online Venue 507 to either the consumer 505 directly or through the retailer 509 to the consumer 505. The connections arrows between the Online Venue 507 represent the flow of information between the Online Venue 507 and other entities. As discussed, the consumers 505 can submit DTBs to the Online Venue 507 which can be posted to the distributor 503. The distributor 503 can respond by transmitting DTSs to the consumers 505. Similarly, the retailers 509 can transmit DTBs to the Online Venue 507 and the distributor 503 can transmit DTSs to the retailer 509. The arrows from the Online Venue 507 can represent purchasing information rather than the distribution of goods or services. Note that the introduction of the Online Venue in this fashion presents a significant opportunity for the Distributor to maximize volume discounts from the Manufacturer, and to significantly reduce the Distributor's inventory carry risk.

With reference to FIG. 9, as the distribution evolves, the manufacturer or service provider 501 can sell goods or services through the Online Venue 507 or the distributor 503. In this embodiment, the consumers 505, retailer 509 or distributor 503 can submit DTBs to the Online Venue 507 which can be posted to the manufacturer or service provider 501. The manufacturer or service provider 501 can respond by transmitting DTSs through the Online Venue 507 to the consumers 505, retailer 509 or distributor 503 in the manner described above. With reference to FIG. 10, eventually the manufacturer or service provider 501 may only use the Online Venue 507 to sell all goods. In this embodiment, the Online Venue 507 may communicate directly with the consumer 505, the retailer 509 and the distributor 503 in the manner described above. With reference to FIG. 11, it is also possible that the retailer and distributor can be eliminated from the distribution channels and the manufacturer or service provider 501 can sell all goods or services through the Online Venue 507 to the consumers 505. The goods and services sold through the Online Venue 507 can both fall under the general category of “products.”

In a developed form, the Online Venue can know what buyers want, when they want it, and the price they are willing to pay, which would facilitate a revolution in the way consumer audiences are targeted through marketing, advertising and promotions.

There are various advantages of the Online Venue buying and selling system and method. For the buyer, the Online Venue system and method represents a very effective way for buyers to get the best deal for the products they want. Additionally, it is the easiest way for buyers to communicate to sellers their desire-to-buy (DTB) goods and services. The process also represents a sanctuary away from the stress of bargain hunting in stores and wasted hours spent searching fruitlessly online for deals. The buyer gets what they want, when they want it, at the price they are willing to pay. For the seller, the Online Venue system and method represents a channel for sellers to target and sell to buyers who might ordinarily fall under their radar of promotions, deals and coupons. The seller no longer has to guess the right discount to offer in order to attract a buyer or guess how much to spend on and how long to run a promotion. The seller simply follows the disclosed process to discover what goods or services the buyers want, when they want the goods or services, and how much they are willing to pay for the goods or services.

While the foregoing written description of the invention enables one of ordinary skill to use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A method comprising:
receiving by a server computer, desire to buys (DTBs) from a plurality of buyers that each include: a description of a product and a maximum price that the buyer is willing to pay for the product;
identifying by the server computer, a first segment of the plurality of buyers from the DTBs that have the maximum purchase prices above a first purchase price;
identifying by the server computer, a second segment of the plurality of buyers from the DTBs that have the maximum purchase prices above a second purchase price that is different than the first purchase price;
receiving by the server computer, a first offer to sell the product to the first segment at or below the first purchase price;
receiving by the server computer, a second offer to sell the product to the second segment at or below the second purchase price;
transmitting by the server computer, the first offer to the first segment of the buyers;
transmitting by the server computer, the second offer to the second segment of the buyers;
receiving by the server computer, acceptances of the first offer from the first segment; and
receiving by the server computer, acceptances of the second offer from the second group.

2. The method of claim 1 further comprising:
activating by the server computer, the first offer for the first segment of the plurality of buyers; and
activating by the server computer, the second offer for the second segment of the plurality of buyers.

3. The method of claim 2 wherein the activating of the first offer includes transmitting a right to buy (RTB) to the first segment of the plurality of buyers which is a commitment from a seller to sell the product to the first segment of the plurality of buyers.

4. The method of claim 1 further comprising:
receiving by the server computer, a minimum number of acceptances required for activation of the first offer for the product before activating the first offer for the first segment of the plurality of buyers;
wherein the first offer includes the minimum number of acceptances required for activation of the first offer for the product.

5. The method of claim 1 further comprising:
receiving by the server computer, commit fees from the first segment of the plurality of buyers wherein the commit fee is a percentage of the first offer.

6. The method of claim 1 further comprising:
transmitting by the server computer, the second offer to some of the first segment of the plurality of buyers.

7. The method of claim 1 further comprising:
identifying by the server computer, a third segment of the plurality of buyers from the DTBs that have the maximum purchase price above a third purchase price that is lower than the second purchase price;
receiving by the server computer, a third offer to sell the product to the third segment of the plurality of buyers at or below the third purchase price;
transmitting by the server computer, the third offer to the third segment of the plurality of buyers;
receiving by the server computer, acceptances of the third offer from the third segment of the plurality of buyers; and
activating by the server computer, the third offer for the third segment of the plurality of buyers.

8. The method of claim 8 further comprising:
transmitting by the server computer, the third offer to some of the first segment of the plurality of buyers and some of the second segment of the plurality of buyers.

9. The method of claim 1 wherein the first offer to sell the product to the first segment of the plurality of buyers is from a first seller and the second offer to sell the product to the second segment of the plurality of buyers is from either the first seller or from a second seller.

10. A method comprising:
receiving by a server computer, desire to buys (DTBs) from a plurality of buyers that each include: a description of a product and a maximum price that the buyer is willing to pay for the product;
identifying by the server computer, a first segment of the plurality of buyers from the DTBs that have the maximum purchase prices above a first purchase price;
identifying by the server computer, a second segment of the plurality of buyers from the DTBs that have the maximum purchase prices above a second purchase price that is different than the first purchase price;
receiving by the server computer, a first offer to sell the product to the first segment of the plurality of buyers at or below the first purchase price from a first seller;
receiving by the server computer, a second offer to sell the product to the first segment of the plurality of buyers at or below the first purchase price from a second seller;
transmitting by the server computer, the first offer to the first segment of the plurality of buyers;
transmitting by the server computer, the second offer to the first segment of the plurality of buyers;
receiving by the server computer, acceptances of the first offer from at least some of the first segment of the plurality of buyers; and
activating by the server computer, the first offer to the first segment of the plurality of buyers who accepted the first offer.

11. The method of claim 10 further comprising:
receiving by the server computer, acceptances of the second offer from some of the first segment of the plurality of buyers.

12. The method of claim 11 further comprising:
activating by the server computer, the second offer to the first segment of the plurality of buyers who accepted the second offer.

13. The method of claim 10 further comprising:
receiving by the server computer, a third offer to sell the product to the second segment of the plurality of buyers at or below the second purchase price from the first seller;
receiving by the server computer, a fourth offer to sell the product to the second segment of the plurality of buyers at or below the second purchase price from the second seller; and
receiving by the server computer, acceptances of the third offer from at least some of the second segment of the plurality of buyers; and
activating by the server computer, the third offer to the second segment of the plurality of buyers who accepted the third offer.

14. The method of claim 13 further comprising:
receiving by the server computer, acceptances of the fourth offer from some of the second segment of the plurality of buyers; and
activating by the server computer, the forth offer to the second segment of the plurality of buyers who accepted the fourth offer.

15. The method of claim 10 further comprising:
receiving by the server computer, a minimum number of acceptances required for activation of the first offer for the product before activating the first offer for the first segment of the plurality of buyers;
wherein the first offer includes the minimum number of acceptances required for activation of the first offer for the product.

16. A method comprising:
receiving by a server computer, desire to buys (DTBs) from a plurality of buyers that each include: a description of a product, a maximum purchase price that the buyer is willing to pay for the product and the DTB timing during which the DTB is valid;
identifying by the server computer, a first segment of the plurality of buyers from the DTBs that have the maximum purchase price above a first purchase price and have similar DTB timings;
identifying by the server computer, a second segment of the plurality of buyers from the DTBs that have the maximum purchase price above a second purchase price that is different than the first purchase price and similar DTB timings;
receiving by the server computer, a first offer to sell the product to the first segment of the plurality of buyers at or below a first purchase price within the DTB timing of the first segment of the plurality of buyers;
receiving by the server computer, a second offer to sell the product to the second segment of the plurality of buyers at or below the second purchase price within the DTB timing of the second segment of the plurality of buyers;
transmitting by the server computer, the first offer to the first segment of the plurality of buyers;
transmitting by the server computer, the second offer to the second segment of the plurality of buyers;
receiving by the server computer, acceptances of the first offer from the first segment of the plurality of buyers; and
receiving by the server computer, acceptances of the second offer from the second segment of the plurality of buyers.

17. The method of claim 16 further comprising:
activating by the server computer, the first offer for the first segment of the plurality of buyers during the DTB timing of the first segment of the plurality of buyers; and
activating by the server computer, the second offer for the second segment of the plurality of buyers during the DTB timing of the second segment of the plurality of buyers.

18. The method of claim 17 wherein the activating of the first offer includes transmitting a right to buy (RTB) to the first segment of the plurality of buyers which is a commitment from a seller to sell the product to the first segment of the plurality of buyers.

19. The method of claim 16 further comprising:
receiving by the server computer, a minimum number of acceptances required for activation of the first offer for the product before activating the first offer for the first segment of the plurality of buyers;
wherein the first offer includes the minimum number of acceptances required for activation of the first offer for the product.

20. The method of claim 16 wherein the first offer to sell the product to the first segment of the plurality of buyers is from a first seller and the second offer to sell the product to the second segment of the plurality of buyers is from either the first seller or from a second seller.
